(19) United States
(12) Patent Application Publication
(10) Pub. No.: US 2012/0060940 A1
(43) Pub. Date: Mar. 15, 2012

(54) Pre-fab pipe traverse plate assy

(76) Inventor: Newberry Francis, Saint Louis, MO (US)

(21) Appl. No.: 13/136,344

(22) Filed: Jul. 30, 2011

(51) Int. Cl. F16L 3/00; F15D 1/00

(52) U.S. Cl. 137/343; 137/561 R

(57) ABSTRACT

The Nature of This Invention is to Show That a Non Automatic Type of equipment Can Serve as a Secondary Backup System to Curtail A Major Catastrophe as Was Witness by The Whole World in The Gulf. This Invention is Not Intended to Replace The Present System Now in Place But to Act as a Safety Net to Protect our Environment. This is an Invention That Will Work if The Correct Strategy is Implemented Within Key Location Site in The Systems Network.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCES LISTING A TABLE, OR A COMPUTER PROGRAM LISTING COMPACT DISC APPENDIX

Not Applicable

### BACKGROUND OF THE INVENTION

This Invention Was Influenced by the “BP” Crude Oil Spill in the Gulf in late April of 2010. The Idea of Doing an Invention in this Industry had Never Cross my Mind. It Became Apparent to me after so Many days Passed With no Progress of Stopping the Flow of Oil in the Gulf, I Felt it was Time to Act as Many Other Americans. It Appear to me all The Attempts and Failure Was a Lost Cause and I Wanted Something Done. Trying to Invent a Way of Dealing With a Constantly Changing Environment Was a Challenge, But I Believed my PRE-FAB TRAVERSE PLATE PIPE ASSEMBLY is a Way to Provide a Safety Net For Failures in the Future.

### BRIEF DESCRIPTION OF THE INVENTION

In View of The Above, It is a Principal Objective of The Present Invention to provide. This Invention Centers Primarily Around Providing a Safety Net for Unforeseen Service Problems Along The Whole Entire NetWork System. These Are Some of The Problems The Industry Face With Direr Consequence, Namely, Well Head Blowout System, Metal Fatigue, and Earthquake, Etc.

The Invention Consist Of a Round Tubular Cylinder Form And The Following Functional Parts, Namely Two Welded Sleeves Extended Beyond Two Flanges at a Predetermine Length And Diameter as Dictated By The Job Requirement. The Flanges Too, Are Welded at Each End Of The Tubular CyLinder For Mating Purposes. The Above Fabrication Is Use Primarily For a “WELL HEAD Blow Out Problem.

The Next Feature Of This Invention Is to Provide The Installation In a New Environment Of The Piping System Without the Use Of Sleeves.

The Internal Feature Of This Invention Consist Of a Steel or Metal Plate Placed Primarily at the Center Of The Tubular Cylinder, But Can Be Located In The Pipe at a Predetermined Location as Long as It Does Not Interfere With Other Components.

The Metal Plate Consist of a Metal Rod Centered On The Face Of Plate Affixed With Nuts And Bolts or By Welding to Hold The Rod In Position. The Metal Rod Extends In a Recessed Hole at The Bottom And Top Of The Cylinder, Thus Allowing Plate Rotation to The Open And Close Positions. The Rod Also Has A Wheel Affix to it For Rotating The Plate Located on The Top Outside of The Cylinder.

The Cylinder Provides Plate Stops at 180 Degrees Of The Plate at its Lateral Axis. One Stop Will Be Place on The Face Of The Plate And The Other Will Be Placed at The Aft End Of The Plate on The Opposite Side Of The Cylinder.

The Invention Also Provides a Hinge Assembly Apparatus to Assist in Lifting The Cylinder For Placement And Mating at The “WELL HEAD.”

### BRIEF DESCRIPTION OF SEVERAL VIEWS OF THE DRAWINGS

FIG. 1 Illustrates The Main Primary Structure Revealing The The Wheel/Rod/Pin Traversing Plate Manual Control, Two Pipe Flange And a Ratchet apparatus For Additional Torque As Needed For Plate Rotation.

FIG. 2 Illustrates Two Sleeves Designed to Provide Mating At Well Head Flange Point When And If a Blow Out Condition Exit At The Well.

FIG. 3 Illustrates The Internal Plate Stops That Curtails Plate Rotation of Travel to 180 Degrees. This Figure Also Show The Steel EyeLet/welded Rod Housing That Hold The Removal Locking Rod In Place, However, The Rod Is Not Shown Here Because This Is The State of Free-Flowing Crude Oil.

FIG. 4 Illustrates The Placement of The Removal Locking Rod Being Held In Place By The Steel Eyelet/welded Rod Housing With The Locking Pin On The Plate Being Used In a Non-Flowing State Of Crude Oil

FIG. 5 Illustrates a Cross-Sectional View Showing a Free-Flowing Crude Oil Configuration.

FIG. 6 Illustrates The Completed Pre-Fab Traverse Plate Assembly Being lowered to The “Well Head” With The Assistance Of The Hinge Apparatus Assembly For Alignment And Mating After Removal Of the Damaged Pipe With The Attached Flange.

FIG. 7 Illustrates a Cross- Sectional View Showing a Non-flowing Crude Oil Configuration Featuring The Internal Plate Stops, The Wheel/Rod/Pin Traversing Manual Control, The Steel Eyelet Welded Rod Housing, The Locking Rod And The Ratchet Mechanical Device.

### DETAILED DESCRIPTION OF THE INVENTION OF THE PREFERRED EMBODIMENTS

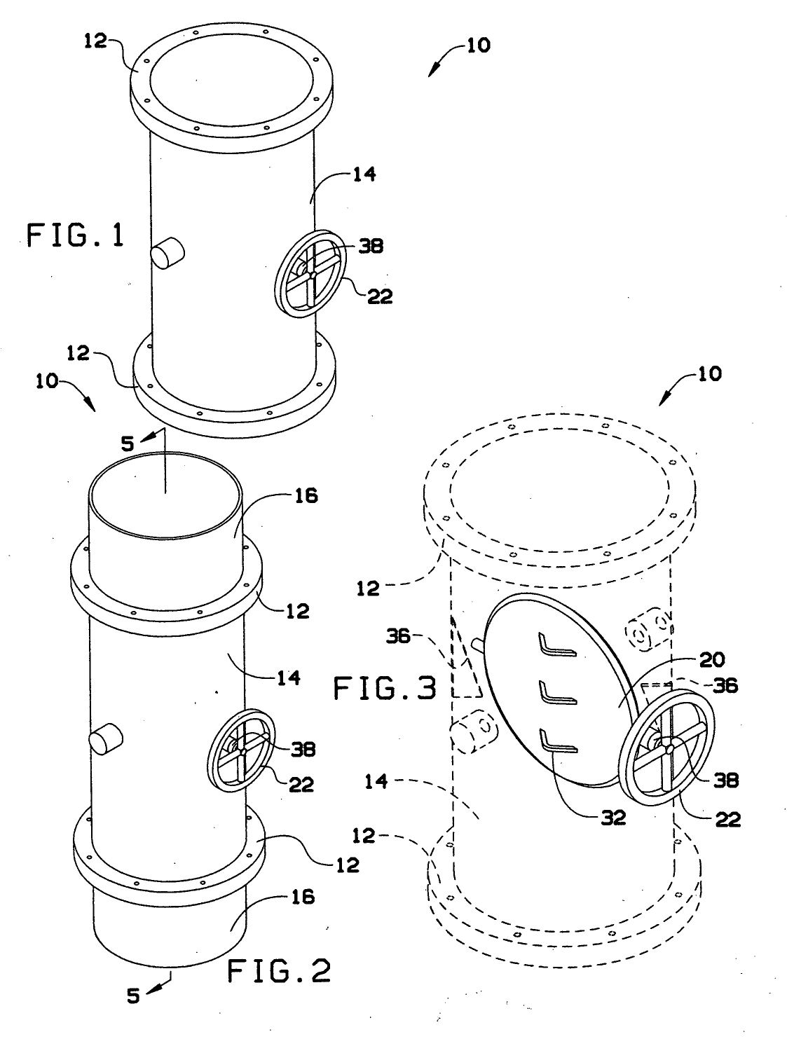

It will Be Readily Understood That The Components Of The Present Invention, as Generally Described And Illustrated In The Figures Herein, Could Be Arranged And Designed In a Wide Variety Of Different Configurations. Thus, The Following More Detailed Description Of The Embodiment Of The System And Method Of The Present Invention And Represented In FIGS. 1 Through 7, is Not Intended to Limit The Scope Of The Invention, as Claimed, But Is Merely Representative Of The Presently Preferred Embodiment Of The Invention. The Presently Preferred Embodiments Of The Invention Will Be Best Understood By Reference to The Drawings Wherein Like Parts Are Designated By like Numerals Throughout.

Turning Now to The drawings, FIG. 1: Is a perspective View Of The Invention 10 Is The Overall Invention, The Two (2) Pipe Flanges 12 Is Supported By The Ends Of The Pipe And Mates With The “WELL HEAD,” The Pipe Is 14, The Wheel/Rod/Pin Traversing Plate manual Control 22, The Ratchet Mechanical Device 38 Assist The Wheel When Additional Torque Is Required,

FIG. 2: Is a Perspective View Of an Alternate Embodiment Of The Invention 10. The Two (2) Flanges 12 Is Consistent With FIG. 1, The Pipe 14 Is Consistent With FIG. 1, The Two (2) Sleeves 16 Is That Part Of The Pipe That Mates With The “WELL HEAD,” The Wheel/Rod/Pin Traversing Plate Manual Control 22 Is Consistent With FIG. 1, The Ratchet Mechanical Device 38 Is Consistent With FIG. 1,

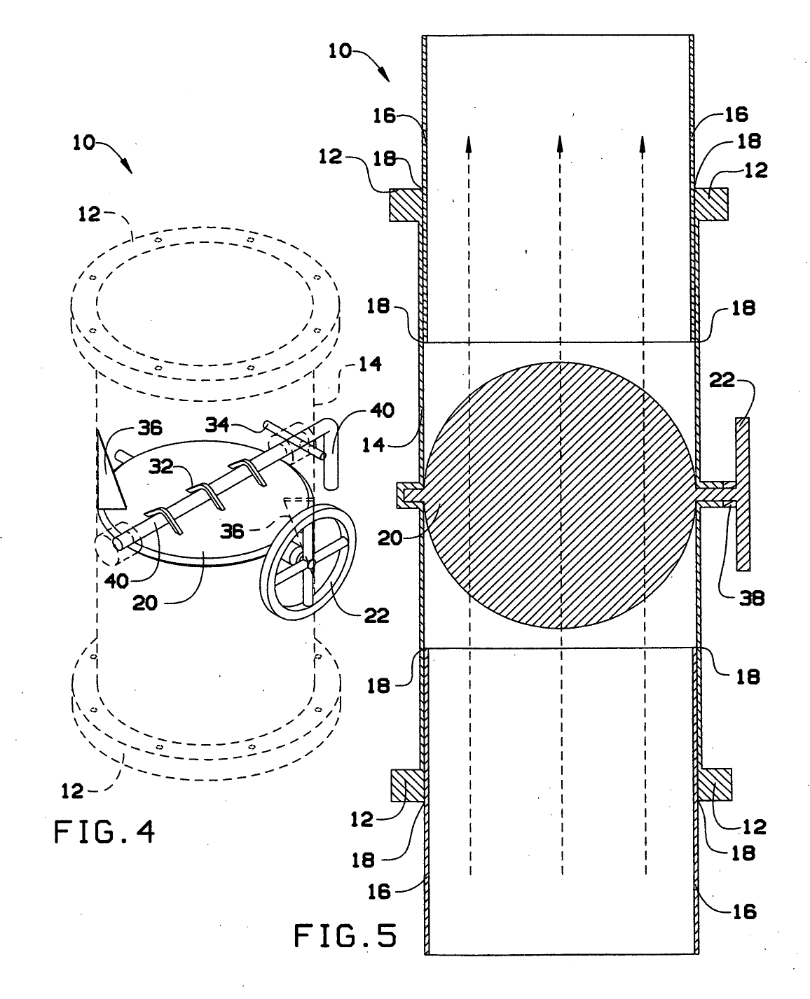

FIG. 3: Is a Perspective View Of The Invention 10 Illustrated In Free-Flowing Configuration. the Two (2) Pipe Flanges 12 Is Consistent With FIG. 1, The Pipe 14 Is Consistent With FIG. 1, The Traversing Plate 20 Is Designed to Allow Flow Of Crude Oil When Open, The Wheel/Rod/Pin Traversing Plate Manual Control 22 Is Consistent With FIG. 1, The Steel Eyelet/Welded Rod Housing 32 Is Provided to Receive The Removal Rod, The Two (2) Internal Plate Stop 36 Is Designed Limit The Plate Rotation to 180 Degree Movement, The Ratchet Mechanical Device 38 Is Consistent With FIG. 1.

FIG. 4: Is a Perspective Of The Invention 10 Illustrated In NonFlowing Configuration. The Two (2) Pipe Flanges 12 Is Consistent With FIG. 1, The Pipe 14 Is Consistent With FIG. 1, The Traversing Plate 20 Is Consistent With FIG. 3, The Wheel/Rod/Pin Traversing Plate Manual Control 22 Is Consistent With FIG. 1, The Steel Eyelet/Welded Rod Housing 32 Is Consistent With FIG. 3, The Rod Retainer Pin And Threaded And Metal Screw Plug 34 Is Provided to Hold The Removal Rod In Place to Keep Crude from Flowing, The Two (2) Internal Plate Stops 36 Is Consistent With FIG. 3, The Removal locking Rod 40 Holds The Plate In Place And Prevents Crude Oil From Flowing, Then Plug The Hole After The Is Removed.

FIG. 5: Is a Section View The Alternate Embodiment Of The Invention 10 Along Line 5-5 in FIG. 2 Illustrated in Free-flowing Configuration. The Two (2) Pipe Flanges 12 Is Consistent With FIG. 1, The Pipe 14 Is Consistent With FIG. 1, The Two (2) Sleeves 16 Is Consistent with FIG. 1, The Eight (8) Weld Points 18 Is Provided to Make Certain The Sleeves Are Secure And Not Allowed to Leak, The Traversing Plate 20 Is Consistent With FIG. 3, The Wheel/Rod/Pin Traversing Plate Manual Control 22 Is Consistent With FIG. 1, The Ratchet Mechanical Device 38 Is Consistent With FIG. 1.

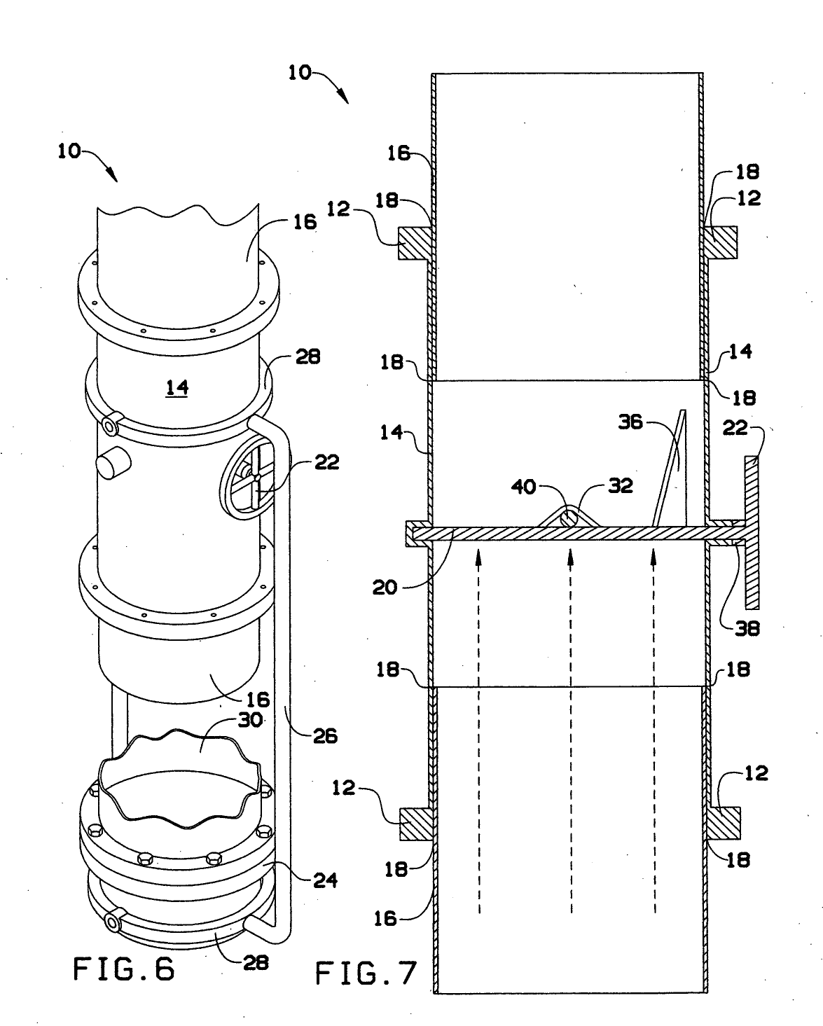

FIG. 6: Is The Perspective View of The Alternate Embodiment of The Invention 10 Shown in Steps of Installation. The Pipe 14 Is Consistent With FIG. 1, The Two (2) Sleeves 16 Is Consistent With FIG. 2, The Well Head Flange 24 Is Removed to Provide For Mating With The Sleeve To The Remaining Flange, The Hinge Clamp Holding Gate 26 Will Assist With Alignment at The Well Head, The Wheel/rod/Pin Traversing Plate Manual Control 22 Is Consistent With FIG. 1, The Hinge Clamp 28 Is Provided to Secure The Pipe Assembly When Mating With The Well Head Flange, The Existing Cut-Off Pipe And Flange to Oil Platform 30 Can Be Removed And Replaced With The Pipe Assembly.

FIG. 7: Is Section View of The Alternate Embodiment of The Invention 10 Illustrated In Non-Flowing Configuration. The Two (2) Pipe Flanges 12 Is Consistent With FIG. 1, The Pipe 14 Is Consistent With FIG. 1, The Two (2) Sleeve 16 Is Consistent With FIG. 2, The Eight (8) Welded Points 18 Is Consistent With FIG. 5, The Traverse Plate 20 Is Consistent With FIG. 3, The Wheel/Rod/Pin Traverse Plate manual Control 22 Is consistent With FIG. 1, The Steel Eyelet/Welded Rod Housing 32 Is Consistent With FIG. 4, The Internal Plate stops 36 Is Consistent With FIG. 3, The Ratchet Mechanical Device 38 Is Consistent With FIG. 1, The Locking Rod 40 Is Consistent With FIG. 4.

What is claimed is:

1. A Non Automatic Invention With The Ability to Allow Free flowing of Crude Oil Under Extreme Pressure and The Ability to Stop Crude Oil Under Extreme Pressure, Comprising an Internal Steel Plate and Ability to Open and Close The Flow of Crude Oil by Manually Rotating a Wheel or Using a Mechanical Ratchet for Added Power.

2. Hinge Assembly Apparatus is used For Lifting The PRE-FAB TRAVERSE PLATE PIPE ASSEMBLY.
